(19) United States
(12) Patent Application Publication
(10) Pub. No.: US 2016/0219582 A1
(43) Pub. Date: Jul. 28, 2016

(54) FLEXIBLE FRAME STRUCTURE

(71) Applicant: NOKIA SOLUTIONS AND NETWORKS, Espoo (FI)

(72) Inventors: Esa Tapani TIIROLA, Kempele (FI); Kari Pekka PAJUKOSKI, Oulu (FI); Bernhard RAAF, Neuried (DE)

(21) Appl. No.: 14/435,642

(22) PCT Filed: Oct. 15, 2012
(86) PCT No.: PCT/EP2012/070367

§ 371 Date: Apr. 14, 2015

(51) Int. Cl. H04W 72/04; H04L 27/26

(52) U.S. Cl. CPC H04W 72/0446; H04L 27/2601

(57) ABSTRACT

Apparatus and method for communication are provided. The solution comprises at least one processor; and at least one memory including computer program code, the at least one memory and the computer program code configured to, with the at least one processor, cause the apparatus at least to perform: to utilize in communication a first frame type comprising OFDMA symbols of first fixed length and a second frame type comprising OFDMA symbols of second fixed length, wherein the first length and the second length may be different; wherein the smallest common multiple of the frame types determines the shortest time interval with which the apparatus may change between the frame types.

### FIELD

The exemplary and non-limiting embodiments of the invention relate generally to wireless communication systems. Embodiments of the invention relate especially to apparatuses, methods, systems, computer programs, computer program products and computer-readable media in communication networks.

### BACKGROUND

Wireless communication systems are constantly under development. Developing systems provide a cost-effective support of high data rates and efficient resource utilization. One communication system under development is the 3rd Generation Partnership Project (3GPP) Long Term Evolution (LTE). An improved version of the Long Term Evolution radio access system is called LTE-Advanced (LTE-A). The LTE and LTE-A are designed to support various services, such as high-speed data. Another developed system is so called Beyond 4G (B4G) radio system which is assumed to be operational in the future.

In future, mobile broadband traffic is expected to increase significantly. A need for systems supporting very high data rates is clear. The design of high data rate communication faces many problems. The systems need to flexibly support a multitude of different data rates, cell sizes and propagation environments, for example.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus in a communication system, comprising: at least one processor; and at least one memory including computer program code, the at least one memory and the computer program code configured to, with the at least one processor, cause the apparatus at least to perform: to utilize in communication a first frame type comprising OFDMA symbols of first fixed length and a second frame type comprising OFDMA symbols of second fixed length, wherein the first length and the second length may be different; wherein the smallest common multiple of the frame types determines the shortest time interval with which the apparatus may change between the frame types.

According to another aspect of the present invention, there is provided a method in a communication system, comprising: utilizing in communication a first frame type comprising OFDMA symbols of first fixed length and a second frame type comprising OFDMA symbols of second fixed length, wherein the first length and the second length may be different; wherein the smallest common multiple of the frame types determines the shortest time interval with which the apparatus may change between the frame types.

### LIST OF DRAWINGS

Embodiments of the present invention are described below, by way of example only, with reference to the accompanying drawings, in which

FIG. 1 illustrates an example of a communication environment;

FIG. 2 illustrates an example of an apparatus applying embodiments of the invention;

FIGS. 3A and 3B illustrate examples of the usage of a first and a second frame type; and

FIG. 4 illustrates examples of second frame types.

### DESCRIPTION OF SOME EMBODIMENTS

Some embodiments of the present invention are applicable to user equipment (UE), transceiver, modem, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN), HSPA (High Speed Packet Access), long term evolution (LTE®, known also as evolved UMTS Terrestrial Radio Access Network E-UTRAN), long term evolution advanced (LTE-A), Wireless Local Area Network (WLAN) based on IEEE 802.11 standard, worldwide interoperability for microwave access (WiMAX®), Bluetooth®, personal communications services (PCS) and systems using ultra-wideband (UWB) technology. IEEE refers to the Institute of Electrical and Electronics Engineers. For example, LTE® and LTE-A are developed by the Third Generation Partnership Project 3GPP. In addition, the development of a Beyond 4G (B4G) radio system has begun.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

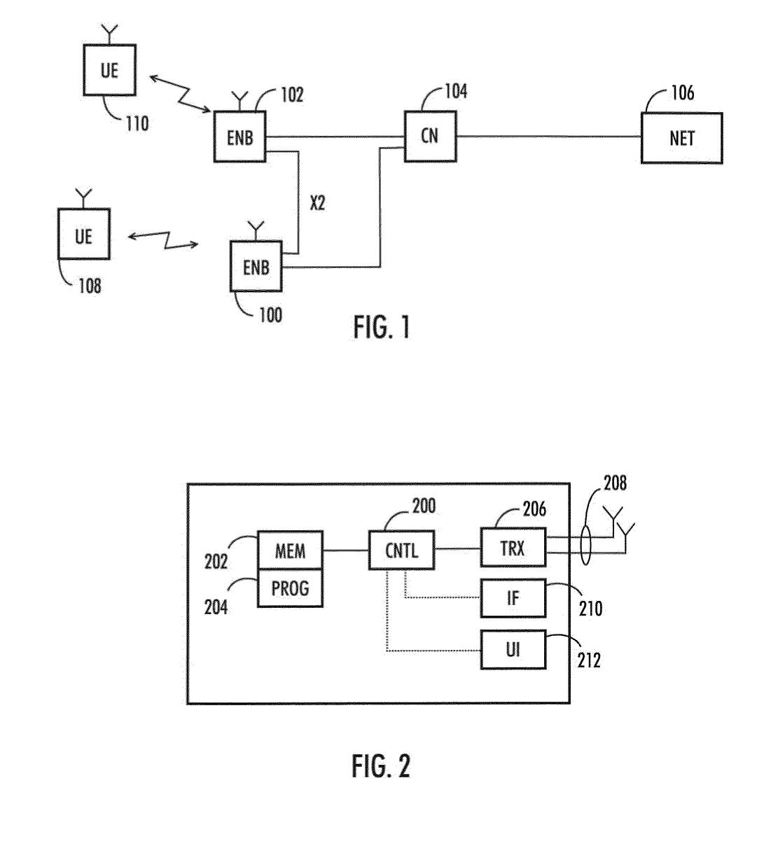

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

FIG. 1 shows eNodeBs 100 and 102 connected to core network CN 104 of a communication system. The eNodeBs are connected to each other over an X2 interface.

The eNodeBs 100, 102 that may also be called base stations of the radio system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The MME (not shown) is responsible for the overall user terminal control in mobility, session/call and state management with assistance of the eNodeBs through which the user terminals connect to the network.

The communication system is also able to communicate with other networks, such as a public switched telephone network or the Internet 106. The communication network may also be able to support the usage of cloud services. It should be appreciated that eNodeBs or their functionalities may be implemented by using any node, host, server or access point etc. entity suitable for such a usage.

User equipment UE refers to a portable communication device. Such communication devices may include wireless mobile communication devices operating with or without a subscriber identification module (SIM), including, but not limited to, the following types of devices: mobile phone, smartphone, Universal Serial Bus (USB) modem, personal digital assistant (PDA), tablet computer, laptop computer. The following embodiments are only examples.

Further, although the apparatuses have been depicted as single entities, different units, processors and/or memory units (not all shown in FIG. 1) may be implemented.

In the example of FIG. 1, UE 108 is connected to the eNodeB 100 and UE 110 is connected to eNodeB 102.

It is obvious for a person skilled in the art that the depicted system is only an example of a part of a radio access system and in practise, the system may comprise a plurality of eNodeBs, the user device may have an access to a plurality of radio cells and the system may comprise also other apparatuses, such as physical layer relay nodes or other network elements, etc. At least one of the NodeBs or eNodeBs may be a Home eNodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The eNodeBs of FIG. 1 may provide any kind of these cells. A cellular radio system may be implemented as a multilayer network including several kinds of cells. Typically, in multilayer networks, one node provides one kind of a cell or cells, and thus a plurality of eNodeBs are required to provide such a network structure.

Recently for fulfilling the need for improving the deployment and performance of communication systems, the concept of “plug-and-play” eNodeBs has been introduced. Typically, a network which is able to use “plug-and-play” eNode Bs, includes, in addition to Home eNodeBs HNBs, a home node B gateway, or HNB-GW (not shown in FIG. 1). A HNB Gateway (HNB-GW), which is typically installed within an operator's network may aggregate traffic from a large number of HNBs back to a core network.

FIG. 2 illustrates an embodiment. The figure illustrates a simplified example of a device in which embodiments of the invention may be applied. In some embodiments, the device may be a base station or eNodeB or a part of an eNodeB configured to communicate with a set of UEs. In some embodiments, the device may be user equipment or a part of user equipment configured to communicate with a base station or eNodeB.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 200 configured to control at least part of the operation of the device.

The device may comprise a memory 202 for storing data. Furthermore the memory may store software 204 executable by the control circuitry 200. The memory may be integrated in the control circuitry.

The device comprises a transceiver 206. The transceiver is operationally connected to the control circuitry 200. It may be connected to an antenna arrangement 208 comprising one more antenna elements or antennas.

The software 204 may comprise a computer program comprising program code means adapted to cause the control circuitry 200 of the device to control a transceiver 206. The control circuitry 200 is configured to execute one or more applications. The applications may be stored in the memory 202.

The device may further comprise an interface 210 operationally connected to the control circuitry 200. If the device is an eNodeB or a part of an eNodeB the interface may connect the apparatus to other respective apparatuses such as eNodeB via X2 interface or to the core network. If the device is an eNodeB or user equipment the interface may be Universal Serial Bus USB or High-Definition Multimedia Interface HDMI, for example.

The device may further comprise a user interface 212 operationally connected to the control circuitry 200. The user interface may comprise one or more of following: a (touch sensitive) display, a keyboard, a microphone and a speaker.

One aspect of future wireless communication systems is that they should support many different cell sized ranging from large umbrella cells to small pico cells. In cells of considerably different size it may be difficult to obtain optimal performance with a single frame structure. Therefore a communication system may utilize more than one frame structure of format depending on the propagation environment, cell load or other criteria.

In an embodiment, the devices of the system may utilize in communication a first frame type comprising OFDMA symbols of first fixed length and a second frame type comprising OFDMA symbols of second fixed length. The number of different frame types may be larger than two.

The symbol lengths in the frame are fixed but in different frame types the length may be different. In an embodiment, the length of a frame of the second frame type is a multiple of the frame length of a frame of the first frame type. The second frame type determines the shortest time interval with which the apparatus may change between the frame types.

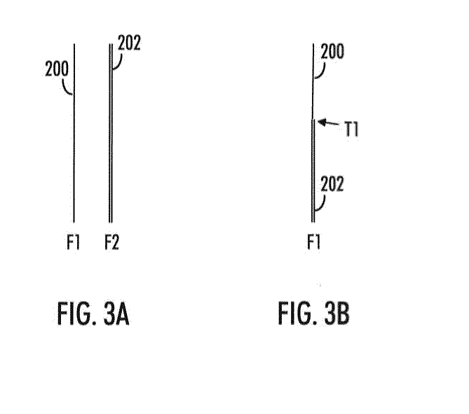

In an embodiment, the frame types are utilised on different carrier frequencies. FIG. 3A illustrates this embodiment. A first frame type 200 is used on carrier frequency F1 and a second frame type 202 is used on carrier frequency F2.

In an embodiment, the frame types are utilised on a same carrier frequency at different time intervals. The time intervals may be successive. FIG. 3B illustrates this embodiment. The first frame type 200 is used on carrier frequency F1 before time instant T1. After the time instant T1 the second frame type 202 is used on the carrier frequency. However, there may be blank time interval between the frames of different types.

The symbol lengths in the frame are fixed but in different frame types the length may be different. One aspect that has an effect on the number of symbols per frame is the usage of guard period GP or cyclic prefix CP. GP or CP is typically used to eliminate inter symbol interference ISI. In many OFDMA systems, a cyclic prefix CP is used. The cyclic prefix is added by copying part of the symbol at the end and attaching it to the beginning of the symbol. When guard period is used, the attached bits are zeros. The length of the CP or GP is designed as such that it exceeds the delay spread in the environment caused by multi-path effect. In large cells the length of the CP or GP is typically longer than in small cells where propagation delays are small.

In addition to eliminating ISI, Time Division Duplex (TDD) systems utilize GP (in addition to CP) as the time for a network node to switch from transmitting phase to receiving phase and vice versa.

Table 1 illustrates an example of the use of CP in LTE/LTE-A based systems where two cyclic prefix lengths, normal and extended CP, are supported. Table 1 shows some system parameters corresponding these CP length options. It also shows what would be the numerology in the case the CP would be removed completely.

TABLE 1

| | LTE | LTE | LTE | |
|---|---|---|---|---|
| | extended CP | normal CP | no CP | |
| TTI length | 1 | 1 | 1 | ms |
| Subcarrier spacing | 15 | 15 | 15 | kHz |
| # of OFDMA symbols/TTI | 12 | 14 | 15 | |
| CP time average | 16.67 | 4.76 | 0.00 | us |
| CP overhead | 20.00 | 6.67 | 0.00 | % |
| Symbol duration average | 66.7 | 66.7 | 66.7 | us |
| Symbol duration inc. CP | 83.3 | 71.4 | 66.7 | us |

Above, TTI denotes transmission time interval.

In future systems the cell sizes are expected to be smaller in some areas and the granularity for adjusting the CP length/overhead in LTE/LTE-A frame type may not be sufficient. Furthermore, continuous development of component technology may enable reduction of the Guard Period used in TDD.

Introducing at least one second frame type offers a solution for example for adjusting the CP/GP length in a flexible manner. For example, the first frame type may be LTE/LTE-A frame type having the frame length of 1 ms. The length of a frame of the second frame type may be formed by creating a “superframe” having the length of N×1 ms, where N>1. The symbol length (subcarrier spacing) in the second frame type may be the same or different compared to LTE/LTE-Advanced.

A number OFDMA symbols (of fixed size) may be allocated in the “superframe” trading-off the CP overhead and CP length. In an embodiment, the unused portion of the “superframe” is allocated for CP/GP—and shared among the OFDMA symbols—in a predefined manner. Furthermore, in a TDD scenario, GP may be shared among different transmission time intervals and uplink/downlink portions in a predefined manner. In an embodiment, all available space is used to transmit symbols and CP or GP is not used. A methodology may be provided to match the number of OFDMA symbols of the “superframe” with the predefined (and variable) TTI length.

It may be noted that the number of OFDMA symbols per “superframe” may even be a prime number or some other number which does not fit with the TTI structure having fixed number of OFDMA symbols/TTI.

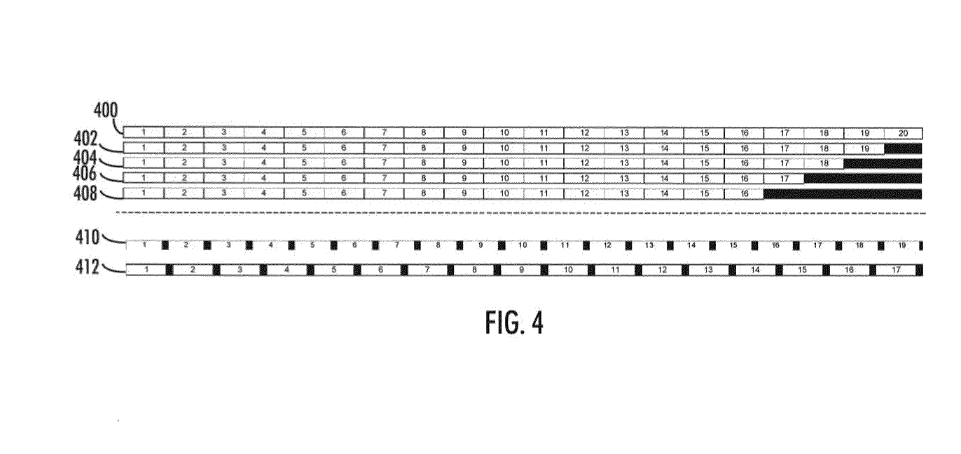

Examples of frame structure arrangements are shown in Table 2 and FIG. 4. Here we give examples of “superframes” of length 2, 5 and 10 ms, i.e., N=2, 5 or 10, and the time corresponding to one single OFDM symbol is given to the CP and shared among all TTIs. It should be noted that the example given in Table 2 considers only the case with a single symbol length (subcarrier spacing of 15 kHz results in symbol length of 66.7 us when the CP is ignored). The example could be easily extended to cover also the case with symbols having different symbol length. This could be made e.g. by selecting the subcarrier spacing to be 60 kHz. This would create symbols with 16.7 us duration (without CP).

TABLE 2

| | LTE | | | | |
|---|---|---|---|---|---|
| | normal CP | “superframe” | | | |
| “superframe” length | 1 | 2 | 5 | 10 | ms |
| Subcarrier spacing | 15 | 15 | 15 | 15 | kHz |
| # of OFDMA symbols/ | 14 | 29 | 74 | 149 | |
| “superframe” | | | | | |
| CP time average | 4.76 | 2.30 | 0.90 | 0.45 | us |
| CP overhead | 6.67 | 3.33 | 1.33 | 0.67 | % |
| Symbol duration average | 66.7 | 66.7 | 66.7 | 66.7 | us |
| Symbol duration inc. CP | 71.4 | 69.0 | 67.6 | 67.1 | us |

FIG. 4 illustrates an example of “superframes”. Figure relates to allocation of 16-20 fixed-size OFDMA symbols in an exemplary “superframe”. Frame 400 comprises 20 symbols without any CP or GP and frames 402, 404, 406 and 408 comprise 19, 18, 17 and 16 symbols, correspondingly. The unused portions of the frames 402, 404, 406 and 408 are allocated for CP or GP (shown as dashed areas) and shared among the OFDMA symbols in predefined manner.

Two examples 410, 412 are given to share the CP/GP among 19 and 17 symbols in the frame. In the former case, only a single OFDM symbol is sacrificed for CP/GP and distributed to the surviving symbols. In the latter case, three symbols are sacrificed which allows to have more CP/GP. Still this length of the CP/GP could not be realized for the normal LTE subframe, as 1.5 symbols are sacrificed per ms, LTE with 1 ms subframe can support a granularity of one OFDM symbol per ms, i.e. either 2 or 4 within 2 ms.

There are several approaches for selecting the transmission time interval TTI for the second frame type (“superframe”).

In an embodiment, a fixed size TTI is used in which the TTIs are allowed to span over multiple “superframes”. In an embodiment, a variable size TTI (within one “superframe”) is used where at least one TTI of the “superframe” is made shorter to match with the “superframe” structure. In addition, a variable size TTI (within “superframe”) may be used where at least one TTI of the “superframe” is extended to match with the “superframe” structure. Further, a selection of either short or long TTIs may be used.

TABLE 3

| | | Option B (M < K) | | Option C (M > K) | |
|---|---|---|---|---|---|
| | | The short TTI is the last TTI | | The long TTI is the last TTI | |
| | Average | Total | Length of last | | Length of last |
| TTI length | TTI length | number of | TTI of the | Total number | TTI of the |
| (OFDMA | (ms), | TTIs per | superframe (M | of TTIs per | superframe (M |
| symbols) | including | superframe | OFDMA symbols) | superframe | OFDMA symbols) |
| K | CP | Option 1 | Option 1 | Option 2 | Option 2 |
| 1 | 0.07 | 74 | — | 74 | — |
| 2 | 0.14 | 37 | — | 37 | — |
| 3 | 0.20 | 25 | 2 | 24 | 5 |
| 4 | 0.27 | 19 | 2 | 18 | 6 |
| 5 | 0.34 | 15 | 4 | 14 | 9 |
| 6 | 0.41 | 13 | 2 | 12 | 8 |
| 7 | 0.47 | 11 | 4 | 10 | 11 |
| 8 | 0.54 | 10 | 2 | 9 | 10 |
| 9 | 0.61 | 9 | 2 | 8 | 11 |
| 10 | 0.68 | 8 | 4 | 7 | 14 |
| 11 | 0.74 | 7 | 8 | 6 | 19 |
| 12 | 0.81 | 7 | 2 | 6 | 14 |
| 13 | 0.88 | 6 | 9 | 5 | 22 |
| 14 | 0.95 | 6 | 4 | 5 | 18 |
| 15 | 1.01 | 5 | 14 | 4 | 29 |
| 16 | 1.08 | 5 | 10 | 4 | 26 |
| 17 | 1.15 | 5 | 6 | 4 | 23 |
| 18 | 1.22 | 5 | 2 | 4 | 20 |
| 19 | 1.28 | 4 | 17 | 3 | 36 |
| 20 | 1.35 | 4 | 14 | 3 | 34 |
| 21 | 1.42 | 4 | 11 | 3 | 32 |
| 22 | 1.49 | 4 | 8 | 3 | 30 |
| 23 | 1.55 | 4 | 5 | 3 | 28 |
| 24 | 1.62 | 4 | 2 | 3 | 26 |
| 25 | 1.69 | 3 | 24 | 2 | 49 |
| 26 | 1.76 | 3 | 22 | 2 | 48 |
| 27 | 1.82 | 3 | 20 | 2 | 47 |
| 28 | 1.89 | 3 | 18 | 2 | 46 |
| 29 | 1.96 | 3 | 16 | 2 | 45 |
| 30 | 2.03 | 3 | 14 | 2 | 44 |
| 31 | 2.09 | 3 | 12 | 2 | 43 |
| 32 | 2.16 | 3 | 10 | 2 | 42 |
| 33 | 2.23 | 3 | 8 | 2 | 41 |
| 34 | 2.30 | 3 | 6 | 2 | 40 |
| 35 | 2.36 | 3 | 4 | 2 | 39 |
| 36 | 2.43 | 3 | 2 | 2 | 38 |
| 37 | 2.50 | 2 | — | 2 | — |
| 38 | 2.57 | 2 | 36 | 1 | 74 |
| 39 | 2.64 | 2 | 35 | 1 | 74 |
| 40 | 2.70 | 2 | 34 | 1 | 74 |
| 41 | 2.77 | 2 | 33 | 1 | 74 |
| 42 | 2.84 | 2 | 32 | 1 | 74 |
| 43 | 2.91 | 2 | 31 | 1 | 74 |
| 44 | 2.97 | 2 | 30 | 1 | 74 |
| 45 | 3.04 | 2 | 29 | 1 | 74 |
| 46 | 3.11 | 2 | 28 | 1 | 74 |
| 47 | 3.18 | 2 | 27 | 1 | 74 |
| 48 | 3.24 | 2 | 26 | 1 | 74 |
| 49 | 3.31 | 2 | 25 | 1 | 74 |
| 50 | 3.38 | 2 | 24 | 1 | 74 |
| 51 | 3.45 | 2 | 23 | 1 | 74 |
| 52 | 3.51 | 2 | 22 | 1 | 74 |
| 53 | 3.58 | 2 | 21 | 1 | 74 |
| 54 | 3.65 | 2 | 20 | 1 | 74 |
| 55 | 3.72 | 2 | 19 | 1 | 74 |
| 56 | 3.78 | 2 | 18 | 1 | 74 |
| 57 | 3.85 | 2 | 17 | 1 | 74 |
| 58 | 3.92 | 2 | 16 | 1 | 74 |
| 59 | 3.99 | 2 | 15 | 1 | 74 |
| 60 | 4.05 | 2 | 14 | 1 | 74 |
| 61 | 4.12 | 2 | 13 | 1 | 74 |
| 62 | 4.19 | 2 | 12 | 1 | 74 |
| 63 | 4.26 | 2 | 11 | 1 | 74 |
| 64 | 4.32 | 2 | 10 | 1 | 74 |
| 65 | 4.39 | 2 | 9 | 1 | 74 |
| 66 | 4.46 | 2 | 8 | 1 | 74 |
| 67 | 4.53 | 2 | 7 | 1 | 74 |
| 68 | 4.59 | 2 | 6 | 1 | 74 |
| 69 | 4.66 | 2 | 5 | 1 | 74 |
| 70 | 4.73 | 2 | 4 | 1 | 74 |
| 71 | 4.80 | 2 | 3 | 1 | 74 |
| 72 | 4.86 | 2 | 2 | 1 | 74 |
| 73 | 4.93 | 2 | 1 | 1 | 74 |
| 74 | 5.00 | 1 | — | 1 | — |

Table 3 illustrates examples of possible TTI selections when at least one TTI is either shorter or longer than others. The “superframe” equals to 5 ms and the corresponding design parameters are shown in Table 2.

The table may be interpreted in following way. We assume a “superframe” of length 5 ms i.e. N=5 and a subcarrier spacing of 15 kHz. Consequently, without any CP there would be 5*15=75 OFDM symbols available. Let us assume that we sacrifice one OFDM symbol for CP of the remaining symbols. This leaves 74 OFDM symbols in the frame. These symbols can be split into 74 TTIs with a single OFDM symbol (row 1) or in 37 TTIs with length 2 each (row 2).

When selecting a TTI length of 3 OFDM symbols however (row 3), it is not possible to have equal sized TTIs as 74 is not divisible by 3. Either we can select 24 TTIs of length 3 and a single one with length 2 giving a total of 25 TTIs. Alternatively, we can select 23 TTIs of length 3 and a single one with length 5 giving a total of 24 TTIs. The same exercise can be done for other TTI lengths.

In the following, some further details related to matching the available OFDMA symbols with the considered TTI length are considered.

Variable size TTI (within one “superframe”) may be used where at least one TTI of the “superframe” is made shorter to match with the “superframe” structure. A single short TTI may be used and this one may be the last TTI. This is the most straightforward approach (considered also in Table 3).

In an embodiment, several short TTIs may be used and they may be grouped together. Using several short TTIs means that each TTI does not have to be significantly shorter but the difference is distributed among several TTIs. The short TTI may be too short to have the HARQ operation in the normal way but instead hybrid automatic repeat request round trip time HARQ RTT can only catch the next but one TTI, which will cause an extra delay. As the next TTI is also a short one, the extra delay incurred by having to resort to the next but one TTI is minimized.

In an embodiment, several short TTIs may be distributed evenly. Typically HARQ operation has a delay of several TTIs. For example, in LTE it is 8 TTIs i.e. 4 times 1 ms i.e. 4 ms. If one of these 4 TTIs is short, say 0.5 ms, then the total RTT is 3.5 ms. If every 4th TTI is short then the RTT is consistently at 3.5 ms. This is an advantage over 4 ms and can then be achieved easily. Therefore it is advantageous to have the short TTIs distributed evenly. The numerical example is for 1 ms TTI but the same applies also to shorter TTIs where the HARQ gets even more challenging.

In an embodiment, a variable size TTI (within “superframe”) is used where at least one TTI of the “superframe” is extended to match with the “superframe structure”.

In an embodiment, a single long TTI may be used and this one may be the last TTI. This is the most straightforward approach (considered also in Table 3).

In an embodiment, several long TTIs may be used and they may be grouped together. Having several adjacent long TTIs may make it possible to reduce the RTT in terms of TTIs e.g. not have a RTT of 4 (normal) TTIs but manage 3 (long) TTIs. This will however typically not be possible with 2 normal and only a single long TTI. Therefore bundling long TTIs together is advantageous.

In an embodiment, several short TTIs may be used and they may be distributed evenly. If it is not possible to use a lower number of TTIs for the RTT as explained above, then it is better to evenly spread the long TTIs in particular if then only one single long TTI (or only a few long TTIs) contribute to the RTT, rather than multiple ones. At least the worst case RTT is then reduced which may be more important than optimizing the best case RTT.

In an embodiment, a selection of either short or long TTIs (i.e. shorter or longer than the normal TTI) are used depending on which option better optimizes RTT. The length of the TTI may be either short or long by selecting the one with least average RTT or least maximum RTT or optimizing some other metric. Alternatively, the number of non-standard TTIs is minimized. Sometimes a single short TTI can lead to a match, then use it instead of multiple long ones. In other cases a single long one may be preferable over multiple short ones.

Usually some OFDM symbols are taken together to form TTIs of variable size. In an embodiment, staggering TTIs is utilised. Different symbols may be grouped together on different Physical Resource Blocks (PRB). Different PRBs may be, for example, different sets of subcarriers within a carrier, or they may be located on different carriers, typically using different carrier frequencies. They might however also be separated in another domain e.g. using code division multiple access CDMA or space division multiple access SDMA within the same frequency range or sent of subcarriers. For example, if we have TTIs of 2 symbols then they may be grouped to pairs in one of the following two ways:

(1, 2); (3, 4); (5, 6); (7, 8); (9, 10); (11, 12) . . .
or
(2, 3); (4, 5); (6, 7); (8, 9); (10, 11); (12, 13) . . . .

Thus, not all TTIs on all PRBs start at the same time but they may start at different times on different PRBs.

Having both of these options available on different PRBs allows starting an HARQ cycle at any symbol and thus queuing delay incurred by the fact that data cannot be transmitted immediately when they are available but only when a new TTI starts may be reduced. Previously, when we have suddenly new data we must wait for the next TTI to be able to transmit them, in the worst case we need to wait for 2 symbols. However, utilising staggered TTIs transmission may be started after at most one symbol. So the worst case waiting time (which adds to the total latency) is reduced by one symbol or 50%.

A disadvantage of this approach is that there is never a “superframe” border that is common for all PRBs. However, using differently sized TTIs as introduced above, this can be achieved e.g. by using the following two options:

(1, 2); (3, 4); (5, 6); (7, 8); (9, 10); (11, 12. 13) . . .
and
(1, 2, 3); (4, 5); (6, 7); (8, 9); (10, 11); (12, 13) . . . .

Both options finish after 13 symbols, due to the two longer TTIs (11, 12. 13) and (1, 2, 3) at the beginning/end of the upper/lower sequence respectively. Thus differently sized TTIs may help to obtain an alignment also in case of using staggered TTIs on different PRBs. This is beneficial if reconfigurations are intended such as shifting the border between the two assignments in the PRB domain or other reconfigurations like changing GP lengths or other parameters in an OFDM system. Having a common start point allows liberal reconfiguration every 13 symbols without losing parts of TTIs for the sake of alignment.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claim.

1. An apparatus in a communication system, comprising:
at least one processor; and
at least one memory including computer program code,
the at least one memory and the computer program code configured to, with the at least one processor, cause the apparatus at least to perform:
to utilize in communication a first frame type comprising OFDMA symbols of first fixed length and a second frame type comprising OFDMA symbols of second fixed length, wherein the first length and the second length may be different, wherein the smallest common multiple of the frame types determines the shortest time interval with which the apparatus may change between the frame types.

2. The apparatus of claim 1, wherein at least one of a cyclic prefix length and a guard period length of the first frame type and second frame type are different.

3. The apparatus of claim 1, wherein the length of a frame of the second frame type being a multiple of the frame length of a frame of the first frame type.

4. The apparatus of claim 1, wherein the frame types are utilised on different carrier frequencies.

5. The apparatus of claim 1, wherein the frame types are utilised on the same carrier frequency at different time intervals.

6. The apparatus of claim 1, the apparatus being configured to utilise in transmission of the second frame type a fixed length transmission time interval which may span over multiple frames.

7. The apparatus of claim 1, the apparatus being configured to utilise in transmission of the second frame type a variable length transmission time interval wherein at least one transmission time interval of a frame is shorter than the other transmission time intervals.

8. The apparatus of claim 1, the apparatus being configured to utilise in transmission of the second frame type a variable length transmission time interval wherein more than one transmission time interval of a frame is shorter than the other transmission time intervals, and the shorter intervals are distributed evenly in the frame.

9. The apparatus of claim 1, the apparatus being configured to utilise in transmission of the second frame type a variable length transmission time interval wherein more than one transmission time interval of a frame is shorter than the other transmission time intervals, and the shorter intervals are grouped together in the frame.

10. The apparatus of claim 1, the apparatus being configured to utilise in transmission of the second frame type a variable length transmission time interval wherein at least one transmission time interval of a frame is longer than the other transmission time intervals.

11. The apparatus of claim 1, the apparatus being configured to utilise in transmission of the second frame type a variable length transmission time interval wherein more than one transmission time interval of a frame is longer than the other transmission time intervals and the longer intervals are distributed evenly in the frame.

12. The apparatus of claim 1, the apparatus being configured to utilise in transmission of the second frame type a variable length transmission time interval wherein more than one transmission time interval of a frame is longer than the other transmission time intervals and the longer intervals are grouped together in the frame.

13. The apparatus of claim 1, the apparatus being configured to utilise in transmission of the second frame type a transmission time interval the length of which is selected to optimize round trip time.

14. The apparatus of claim 1, the apparatus being configured to utilise in transmission of the second frame type, wherein part of the frame length is reserved for guard periods or prefixes, which are distributed between symbols or transmission time intervals of the frame.

15. The apparatus of claim 1, the apparatus being configured to utilise in transmission of the second frame type, wherein the length of the frame is a multiple of the length of the frame used in a Long Term Evolution Advanced system.

16. The apparatus of claim 1, wherein the apparatus is configured to arrange hybrid automatic repeat request timing to follow frame symbol indexes.

17. The apparatus of claim 1, wherein the apparatus is configured to arrange hybrid automatic repeat request timing to follow transmission time interval indexes.

18. The apparatus of claim 1, wherein transmission time intervals start at different times on different physical resource blocks.

19. The apparatus of claim 1, wherein the apparatus is a base station of a communication system.

20. The apparatus of claim 1, wherein the apparatus is user equipment of a communication system.

21. A method in a communication system, comprising:
utilizing in communication a first frame type comprising OFDMA symbols of first fixed length and a second frame type comprising OFDMA symbols of second fixed length, wherein the first length and the second length may be different, wherein the smallest common multiple of the frame types determines the shortest time interval with which the apparatus may change between the frame types.

22. The method of claim 21, wherein at least one of a cyclic prefix length and a guard period length of the first frame type and second frame type are different.

23. The method of claim 21, wherein the length of a frame of the second frame type being a multiple of the frame length of a frame of the first frame type.

24. The method of claim 21, wherein the frame types are utilised on different carrier frequencies.

25. The method of claim 21, wherein the frame types are utilised on the same carrier frequency at different time intervals.

26. The method of claim 21, further comprising utilising in transmission of the second frame type a fixed length transmission time interval which may span over multiple frames.

27. The method of claim 21, further comprising utilising in transmission of the second frame type a variable length transmission time interval wherein at least one transmission time interval of a frame is shorter than the other transmission time intervals.

28. The method of claim 21, further comprising utilising in transmission of the second frame type a variable length transmission time interval wherein more than one transmission time interval of a frame is shorter than the other transmission time intervals, and the shorter intervals are distributed evenly in the frame.

29. The method of claim 21, further comprising utilising in transmission of the second frame type a variable length transmission time interval wherein more than one transmission time interval of a frame is shorter than the other transmission time intervals, and the shorter intervals are grouped together in the frame.

30. The method of claim 21, further comprising utilising in transmission of the second frame type a variable length transmission time interval wherein at least one transmission time interval of a frame is longer than the other transmission time intervals.

31. The method of claim 21, further comprising utilising in transmission of the second frame type a variable length transmission time interval wherein more than one transmission time interval of a frame is longer than the other transmission time intervals and the longer intervals are distributed evenly in the frame.

32. The method of claim 21, further comprising utilising in transmission of the second frame type a variable length transmission time interval wherein more than one transmission time interval of a frame is longer than the other transmission time intervals and the longer intervals are grouped together in the frame.

33. The method of claim 21, further comprising utilising in transmission of the second frame type a transmission time interval the length of which is selected to optimize round trip time.

34. The method of claim 21, further comprising utilising in transmission of the second frame type, wherein part of the frame length is reserved for guard periods or prefixes, which are distributed between symbols or transmission time intervals of the frame.

35. The method of claim 21, further comprising utilising in transmission of the second frame type, wherein the length of the frame is a multiple of the length of the frame used in a Long Term Evolution Advanced system.

36. The method of claim 21, further comprising arranging hybrid automatic repeat request timing to follow frame symbol indexes.

37. The method of claim 21, further comprising arranging hybrid automatic repeat request timing to follow transmission time interval indexes.

38. The method of claim 21, wherein transmission time intervals start at different times on different physical resource blocks.

39. A computer program product embodied on a distribution medium readable by a computer and comprising program instructions which, when loaded into an apparatus, execute the method according to claim 21.
